(19) United States
(12) Patent Application Publication
(10) Pub. No.: US 2025/0080546 A1
(43) Pub. Date: Mar. 6, 2025

(54) SYSTEM AND METHOD OF DETECTING MULTIFACTOR AUTHORIZATION ATTACK

(71) Applicants: RAKUTEN SYMPHONY, INC., Tokyo (JP); RAKUTEN MOBILE, INC., Tokyo (JP)

(72) Inventors: Sota AOKI, Tokyo (JP); Maheshwaran PALANIVELU, Tokyo (JP); Winston PONIENTE, Tokyo (JP)

(73) Assignees: RAKUTEN SYMPHONY, INC., Tokyo (JP); RAKUTEN MOBILE, INC., Tokyo (JP)

(21) Appl. No.: 18/021,411

(22) PCT Filed: Jan. 19, 2023
(86) PCT No.: PCT/US2023/011121

§ 371 Date: Feb. 15, 2023

(51) Int. Cl. H04L 9/40

(52) U.S. Cl. CPC H04L 63/1416

(57) ABSTRACT

A method of detecting an MFA attack includes identifying at least one MFA failure condition corresponding to at least one failed login attempt of a user, detecting a successful login attempt of the user following the identification of the at least one MFA failure condition, determining whether a login violation condition of the successful login attempt occurs within a first predetermined time period from the detection of the successful login attempt, determining an MFA attack occurs based on determining that the login violation condition occurs within the first predetermined time period.

### 1. FIELD

Apparatuses and methods consistent with example embodiments of the present disclosure relate to detecting multifactor authentication (MFA) attacks.

### 2. DESCRIPTION OF RELATED ART

In related art, multifactor authentication (MFA) attacks, such as MFA fatigue (also referred to as MFA push spam, MFA bombing, and/or prompt bombing), is a strategy used by hackers to circumvent MFA when breaking into user accounts. Using stolen, leaked, or guessed credentials for login attempts, the account owner (i.e., the real user) may be continuously bombarded with prompts, alerts, notifications, etc., requesting verification of identity and/or verification of the login attempt. The bombardment may continue until the user is psychologically worn and authorizes the notifications, the user accidentally verifies the false login attempt, etc.

Since the MFA attack employs social engineering techniques, there is no technical way to prevent such attacks in the related art.

### SUMMARY

According to embodiments, systems and methods are provided for detecting multifactor authentication (MFA) attacks.

According to an aspect of the disclosure, a method of detecting an MFA attack may include identifying at least one MFA failure condition corresponding to at least one failed login attempt of a user, detecting a successful login attempt of the user following the identification of the at least one MFA failure condition, determining whether a login violation condition of the successful login attempt occurs within a first predetermined time period from the detection of the successful login attempt, determining an MFA attack occurs based on determining that the login violation condition occurs within the first predetermined time period.

According to an aspect of the disclosure, a system for detecting an MFA attack may include a memory storing instructions and a processor configured to execute the instructions to identify at least one MFA failure condition corresponding to at least one failed login attempt of a user, detect a successful login attempt of the user following the identification of the at least one MFA failure condition, determine whether a login violation condition of the successful login attempt occurs within a first predetermined time period from the detection of the successful login attempt, and determine that an MFA attack occurs based on determining that the login violation condition occurs within the first predetermined time period.

According to an aspect of the disclosure, a non-transitory computer-readable storage medium may store instructions that, when executed by at least one processor, cause the at least one processor to identify at least one MFA failure condition corresponding to at least one failed login attempt of a user, detect a successful login attempt of the user following the identification of the at least one MFA failure condition, determine whether a login violation condition of the successful login attempt occurs within a first predetermined time period from the detection of the successful login attempt, and determine an MFA attack occurs based on determining that the login violation condition occurs within the first predetermined time period.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIGS. 1A, 1B and 1C are diagrams illustrating an example of a multifactor authentication (MFA) attack, according to an embodiment;

FIG. 2 is a diagram illustrating an operation flow for detection of an MFA attack, according to an embodiment;

FIG. 3 is a flowchart of a method for detection of an MFA attack, according to an embodiment;

FIG. 4 is a diagram of an example environment in which systems and/or methods, described herein, may be implemented; and

FIG. 5 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which a multifactor authentication (MFA) attack may be detected. The MFA attack may be referred to as MFA fatigue, MFA push spam, MFA bombing, prompt bombing, etc. The system may identify at least one MFA failure condition corresponding to at least one failed login attempt of a user, detect a successful login attempt of the user following the identification of the at least one MFA failure condition, determine whether a login violation condition of the successful login attempt occurs within a first predetermined time period from the detection of the successful login attempt, and determine that an MFA attack occurs based on determining that the login violation condition occurs within the first predetermined time period.

Thus, the system and method may detect MFA attacks that are followed by a successful login from a new source internet protocol (IP) address or location based on a customized threat scenario. The customized threat scenario may include one or a combination of multiple threat identifiers and/or predefined conditions. Accordingly, attack behaviors specific to MFA attacks followed by successful login attempts from new IP addresses or new locations may be accurately and effectively detected, thereby increasing the likelihood of capturing a true positive MFA attack.

Provided are systems and methods having threat scenarios that combine multiple threat identifiers, such as MFA failure conditions and login violation conditions, which allow for sequential event detection where an attacker sends multiple MFA push notifications to a victim device followed by a successful login attempt from a new source IP address or location. The systems and methods provide prompt responses following the detection of the suspected attack activity, which may prevent major data breaches that can lead to loss in revenue and/or reputation.

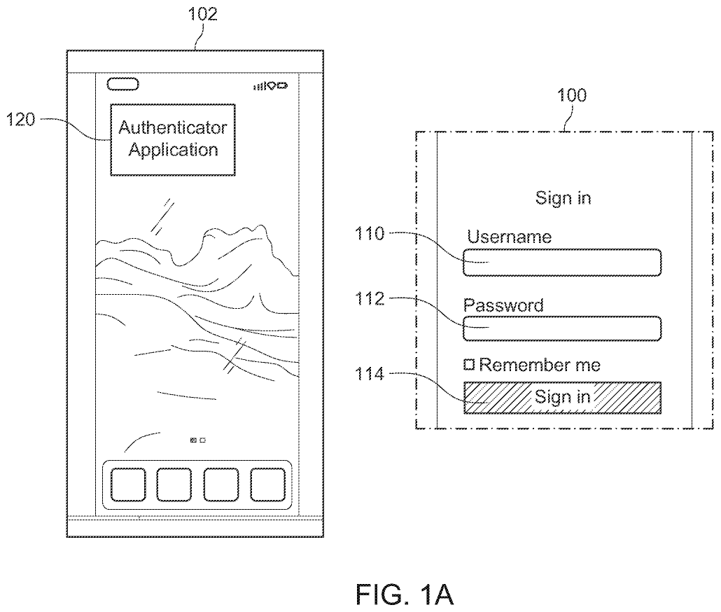

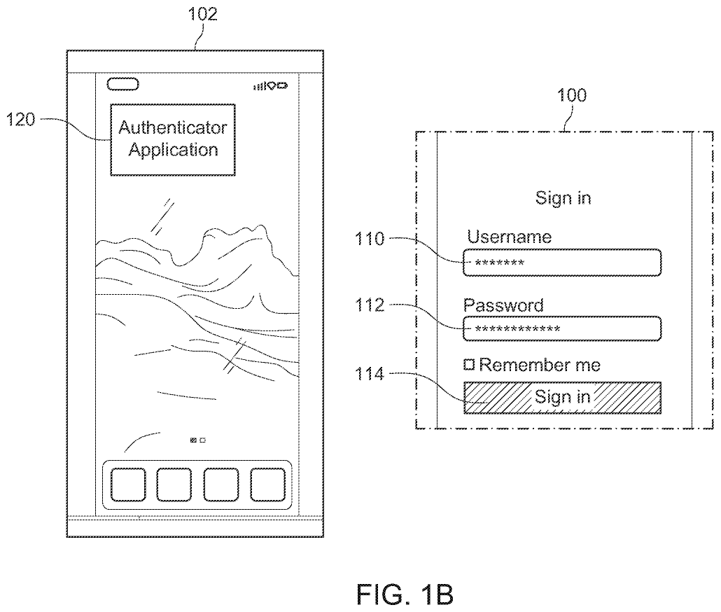

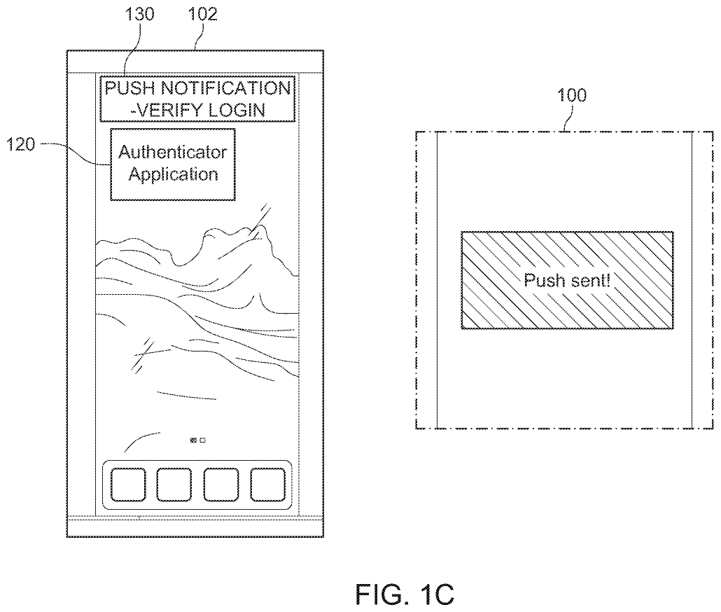

FIGS. 1A, 1B and 1C are diagrams illustrating an example of an MFA attack, according to an embodiment. Referring to FIG. 1A, a screen of an access device 100 and a screen of a user device 102 are shown. The access device 100 may correspond to a device providing an access prompt into a system, including a user name field 110 and a password field 112. The user device 102 may correspond to a device of a user that includes an authenticator application 120 (e.g., Microsoft Authenticator, Google Authenticator, Okta, etc.) for MFA, verifying a login attempt to the system being accessed from the access device 100. It is noted that the access device 100 and the user device 102 may be the same device in some embodiments, but are depicted as separate devices for ease of description.

As shown in FIG. 1B, a perpetrator of an MFA attack may illicitly obtain the user's credentials (e.g., via hacking, via guessing, via data leaks, directly from the user, etc.) and then enter the credentials into the access device 100 via the user name field 110 and the password field 112. Upon entering the credentials into the access device 100, the perpetrator may submit the credentials via the “sign in” icon 114. Referring to FIG. 1C, upon submitting the credentials, the authenticator application 120 may be initiated, providing a push notification 130 to the user device 102 requesting confirmation of the login attempt by the perpetrator on the access device 100. A push notification 130 is depicted, however other verification notifications may be provided to the user device 102, such as emails, additional passcodes, etc., as will be understood by one of ordinary skill in the art from the disclosure herein. In response to receiving the push notification 130, the user of the user device 102 may recognize the login attempt as being fraudulent and then ignore the push notification 130 or decline/fail to confirm the login attempt, resulting in a failed login attempt by the perpetrator.

In an MFA attack scheme, the perpetrator may continue to repeat the fraudulent access to the system from the access device 100, causing multiple push notifications to be repeatedly sent to the user of the user device 102. As the MFA attack fatigue sets in, or for other reasons (such as user error), the user of the user device 102 may accept or authorize the login attempt via the authenticator application 120, causing a successful login attempt after one or more failed login attempts occur. Accordingly, the provided systems and methods disclosed herein are configured to further detect whether the successful login attempt is the result of an MFA attack, and then correct the situation accordingly.

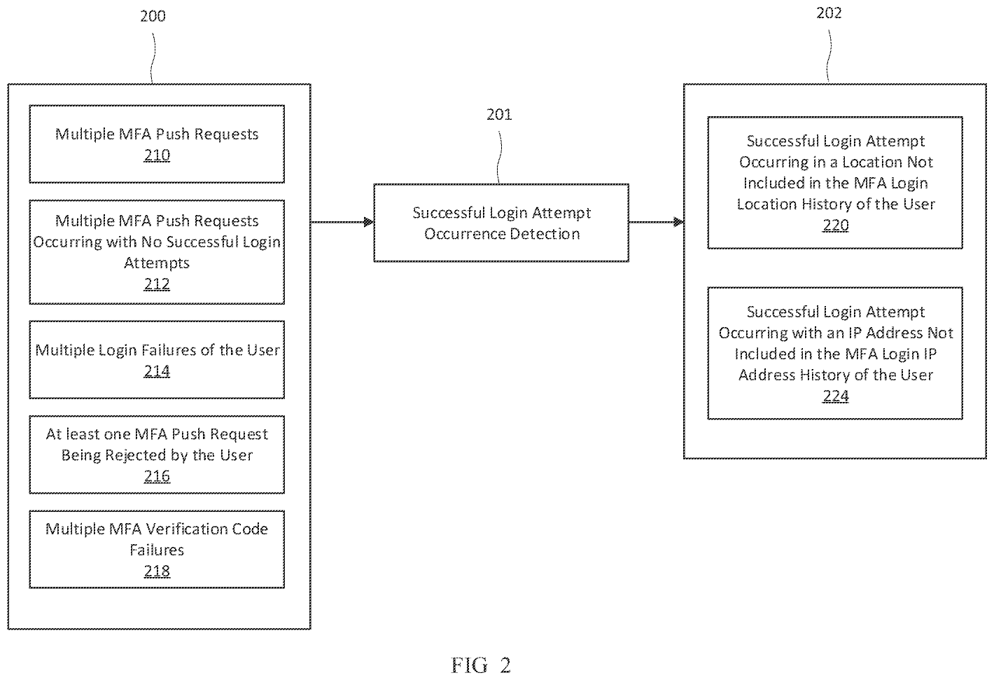

FIG. 2 is a diagram illustrating an operation flow for detection of an MFA attack, according to an embodiment. The detection of an MFA attack may include two stages, a first stage 200 and a second stage 202. The first stage 200 may include identification of MFA failure conditions, and the second stage 202 may include determination of login violation conditions, as is described in detail below.

In the first stage 200, the system may be configured to identify at least one MFA failure condition. The MFA failure conditions may correspond to failed login attempts of the user (e.g., failed login attempts corresponding to the user credentials but implemented by an MFA attack perpetrator). The MFA failure conditions may include multiple MFA push requests 210. Multiple MFA push requests may correspond to a number of push requests sent to a user device via an authenticator application to verify a login attempt. The system may be configured to determine that the MFA failure condition of multiple MFA push requests 210 is satisfied when the number of MFA push requests exceeds a predetermined number of MFA push requests.

The MFA failure conditions may include a condition 212 of multiple MFA push requests occurring with no successful login attempts. Condition 212 differs from condition 210 in that the system may be configured to determine a number of MFA push requests without successful login attempts, further determining whether a successful login attempt occurs in conjunction with the multiple MFA push requests. That is, in some example embodiments, the system may be configured to detect both a number of MFA push requests and the number of MFA push requests occurring without successful logins. For example, regarding condition 212, the system may identify that the MFA failure condition occurs when both a predetermined number of MFA push notifications are sent and no successful login attempts accompany the predetermined number of MFA push notifications, as opposed to condition 210, where the system may determine an MFA failure condition occurs when a predetermined number of MFA push notifications are sent, regardless as to whether any successful login attempt is made (in other words, condition 210 may be satisfied even with a successful login attempt).

The MFA failure conditions may include a condition 214 where multiple MFA login failures of the user occurs. That is, the system may determine that an MFA failure condition has occurred based on a number of login failures occurring exceeding a predetermined number of allowable login failures. As opposed to conditions 210 and 212, for condition 214, the system may not consider the number of push notifications in determining whether condition 214 is satisfied.

The MFA failure conditions may include condition 216 of at least one MFA push request being rejected by the user. That is, the system may track whether the user rejects authentication push requests provided by the authenticator application. The system may be configured to determine condition 216 is satisfied based on one push request being rejected by the user and/or based on a predetermined number of push requests being rejected by the user. As opposed to conditions 210 and 212, for condition 216, the system may not necessarily consider the number of push requests being sent (i.e., the system may only consider the number of push requests that are rejected by the user regardless of the number of push notifications being sent).

The MFA failure conditions may include condition 218 of multiple MFA verification code failures. In some example embodiments, instead of sending a push notification to a user to simply tap and accept a login attempt, the authenticator application may be configured to send the user an additional verification code to complete the MFA for access to the system. Thus, the system may determine the MFA failure condition 218 to be satisfied when a predetermined number (e.g., one or more) of MFA verification code failures occur.

The conditions 210-218 shown in the first stage 200 may be implemented individually, separately from other conditions, in conjunction with other conditions, and/or in combination with other conditions as will be understood by one of ordinary skill in the art from the disclosure herein.

In response to identifying an MFA failure condition occurring in the first stage 200, the system may in operation 201 determine whether a successful login attempt has occurred. The system may determine that a successful login attempt has occurred in the first stage 200 depending on the identified MFA failure condition, or the system may subsequently determine whether a successful login attempt has occurred in response to identifying an MFA failure condition has occurred in the first stage 200. Based on determining that a successful login attempt has occurred, the system may proceed to the second stage 202. In some embodiments, the system may assume that a successful login attempt has occurred and omit operation 201.

In the second stage 202, the system may determine whether a login violation condition of the successful login attempt has occurred. Prior to determining whether a login violation condition has occurred, the system may store a login history of a user over a predetermined time interval (e.g., a 90 day history or other suitable interval). The login history of the user may include an MFA login location history (e.g., city, country, etc.) as well as an MFA login IP address history of the user. Based on the login history of the user, the system may determine whether an MFA attack occurs, as is described in detail below.

The login violation condition may include condition 220 of a successful login attempt occurring in a location not included in the MFA login location history of the user and/or condition 222 of a successful login attempt occurring with an IP address not included in the MFA login IP address history of the user. Furthermore, the system may be configured to determine whether an MFA attack occurs by determining wither condition 220 or condition 222 occurs within a predetermined time period of a condition from the first stage 200 occurring. For example, in response to identifying an MFA failure condition occurring in the first stage 200, the system may be configured to determine whether an MFA attack occurs based on condition 220 and/or condition 222 occurring within about an hour of a condition from the first stage 200 being identified. Other predetermined time periods may be utilized based on parameters of authenticator applications, system accesses, or other factors as will be understood by one of ordinary skill in the art from the disclosure herein. Thus, when a condition 220/222 from the second stage 202 occurs within the predetermined time period from a condition 210-218 occurring from the first stage 200, the system may determine than an MFA attack has occurred.

In response to determining an MFA attack has occurred, the system may disconnect the access of the user (i.e., the access of the perpetrator), may send notifications to the user for credential changes, may reinitialize the access system, and/or other actions that would discontinue the MFA attack/successful malicious login.

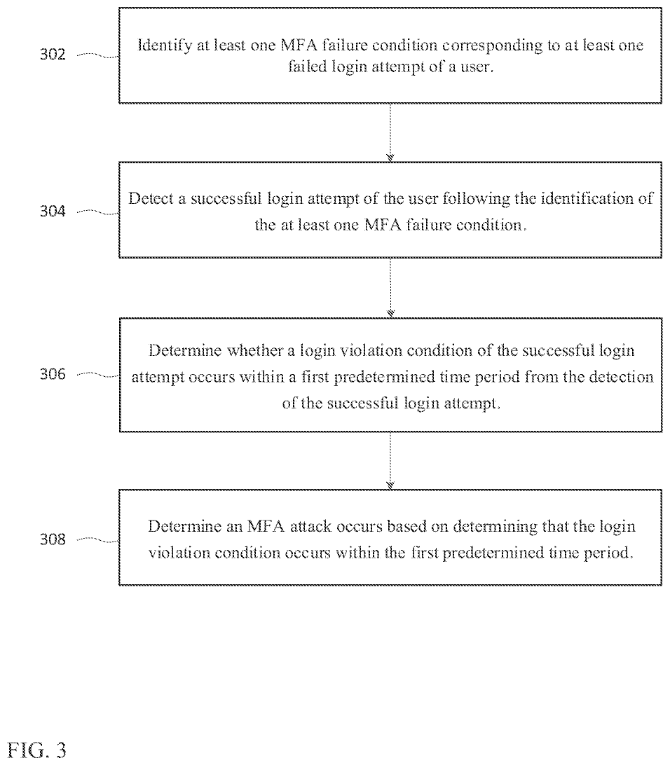

FIG. 3 is a flowchart of a method for detection of an MFA attack, according to an embodiment. In operation 302, the system may identify at least one MFA failure condition corresponding to at least one failed login attempt of a user. In operation 304, the system may detect a successful login attempt of the user following the identification of the at least one MFA failure condition. In operation 306, the system may determine whether a login violation condition of the successful login attempt occurs within a first predetermined time period from the detection of the successful login attempt. In operation 308, the system may determine an MFA attack occurs based on determining that the login violation condition occurs within the first predetermined time period.

The system may store a login history of the user over a second predetermined time period, the login history including at least one of an MFA login location history of the user and an MFA login IP address history of the user. The login violation condition may include the successful login attempt occurring at a location not included in the MFA login location history of the user, and the successful login attempt occurring with an IP address not included in the MFA login IP address history of the user. The predetermined time period may be about one hour. The at least one MFA failure condition corresponding to the at least one failed login attempt of the user may include multiple MFA push requests occurring, multiple MFA push requests occurring with no successful login attempts, multiple MFA login failures of the user, at least one MFA push request being rejected by the user, and multiple MFA verification code failures.

By identifying MFA failure conditions, subsequent successful login attempts, and then login violation conditions, attack behaviors specific to MFA attacks followed by successful login attempts from new IP addresses or new locations may be accurately and effectively detected, thereby increasing the likelihood of capturing a true positive MFA attack.

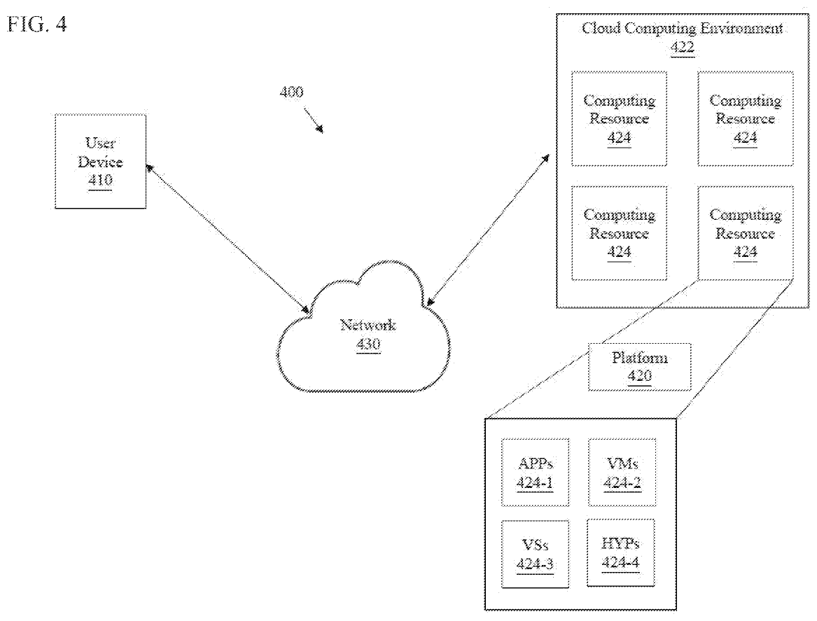

FIG. 4 is a diagram of an example environment 400 in which systems and/or methods, described herein, may be implemented. As shown in FIG. 4, environment 400 may include a user device 410, a platform 420, and a network 430. Devices of environment 400 may interconnect via wired connections, wireless connections, or a combination of wired and wireless connections. In embodiments, any of the functions and operations described with reference to FIG. 1 above may be performed by any combination of elements illustrated in FIG. 4.

User device 410 includes one or more devices capable of receiving, generating, storing, processing, and/or providing information associated with platform 420. For example, user device 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 410 may receive information from and/or transmit information to platform 420.

Platform 420 includes one or more devices capable of receiving, generating, storing, processing, and/or providing information. In some implementations, platform 420 may include a cloud server or a group of cloud servers. In some implementations, platform 420 may be designed to be modular such that certain software components may be swapped in or out depending on a particular need. As such, platform 420 may be easily and/or quickly reconfigured for different uses.

In some implementations, as shown, platform 420 may be hosted in cloud computing environment 422. Notably, while implementations described herein describe platform 420 as being hosted in cloud computing environment 422, in some implementations, platform 420 may not be cloud-based (i.e., may be implemented outside of a cloud computing environment) or may be partially cloud-based.

Cloud computing environment 422 includes an environment that hosts platform 420. Cloud computing environment 422 may provide computation, software, data access, storage, etc. services that do not require end-user (e.g., user device 410) knowledge of a physical location and configuration of system(s) and/or device(s) that hosts platform 420. As shown, cloud computing environment 422 may include a group of computing resources 424 (referred to collectively as “computing resources 424” and individually as “computing resource 424”).

Computing resource 424 includes one or more personal computers, a cluster of computing devices, workstation computers, server devices, or other types of computation and/or communication devices. In some implementations, computing resource 424 may host platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, or the like.

Application 424-1 includes one or more software applications that may be provided to or accessed by user device 410. Application 424-1 may eliminate a need to install and execute the software applications on user device 410. For example, application 424-1 may include software associated with platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program, and may support a single process. In some implementations, virtual machine 424-2 may execute on behalf of a user (e.g., user device 410), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems, and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

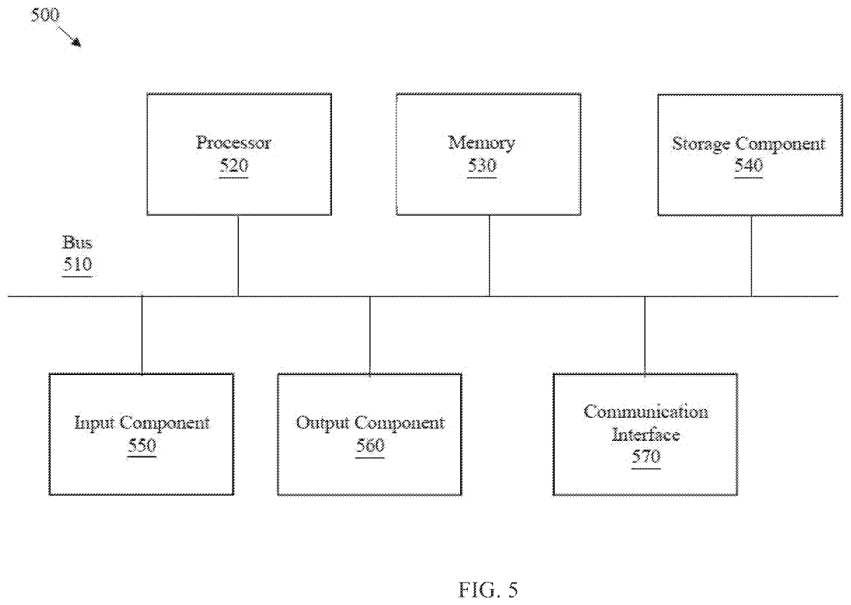

FIG. 5 is a diagram of example components of a device 500. Device 500 may correspond to user device 410 and/or platform 420. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

Device 500 may perform one or more processes described herein. Device 500 may perform these processes in response to processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any one of the operations or processes of FIGS. 1A, 1B, 1C, 2 and 3 may be implemented by or using any one of the elements illustrated in FIGS. 4 and 5.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of detecting a multifactor authentication (MFA) attack, the method comprising:
identifying at least one MFA failure condition corresponding to at least one failed login attempt of a user;
detecting a successful login attempt of the user following the identification of the at least one MFA failure condition;
determining whether a login violation condition of the successful login attempt occurs within a first predetermined time period from the detection of the successful login attempt; and
determining an MFA attack occurs based on determining that the login violation condition occurs within the first predetermined time period.

2. The method of claim 1, further comprising storing a login history of the user over a second predetermined time period, the login history comprising at least one of an MFA login location history of the user and an MFA login internet protocol (IP) address history of the user.

3. The method of claim 2, wherein the login violation condition of the successful login attempt comprises at least one of:
the successful login attempt occurring at a location not included in the MFA login location history of the user; and
the successful login attempt occurring with an IP address not included in the MFA login IP address history of the user.

4. The method of claim 1, wherein the first predetermined time period comprises about one hour.

5. The method of claim 1, wherein the at least one MFA failure condition corresponding to the at least one failed login attempt of the user comprises at least one of:
multiple MFA push requests occurring; and
multiple MFA push requests occurring with no successful login attempts.

6. The method of claim 1, wherein the at least one MFA failure condition corresponding to the at least one failed login attempt of the user comprises multiple MFA login failures of the user.

7. The method of claim 1, wherein the at least one MFA failure condition corresponding to the at least one failed login attempt of the user comprises at least one MFA push request being rejected by the user.

8. The method of claim 1, wherein the at least one MFA failure condition corresponding to the at least one failed login attempt of the user comprises multiple MFA verification code failures.

9. A system for detecting a multifactor authentication (MFA) attack, the system comprising:
a memory storing instructions; and
a processor configured to execute the instructions to:
identify at least one MFA failure condition corresponding to at least one failed login attempt of a user;
detect a successful login attempt of the user following the identification of the at least one MFA failure condition;
determine whether a login violation condition of the successful login attempt occurs within a first predetermined time period from the detection of the successful login attempt; and
determine that an MFA attack occurs based on determining that the login violation condition occurs within the first predetermined time period.

10. The system of claim 9, wherein the processor is further configured to execute the instructions to store a login history of the user over a second predetermined time period, the login history comprising at least one of an MFA login location history of the user and an MFA login internet protocol (IP) address history of the user.

11. The system of claim 10, wherein the login violation condition of the successful login attempt comprises at least one of:
the successful login attempt occurring at a location not included in the MFA login location history of the user; and
the successful login attempt occurring with an IP address not included in the MFA login IP address history of the user.

12. The system of claim 9, wherein the first predetermined time period comprises about one hour.

13. The system of claim 9, wherein the at least one MFA failure condition corresponding to the at least one failed login attempt of the user comprises at least one of:
multiple MFA push requests occurring; and
multiple MFA push requests occurring with no successful login attempts.

14. The system of claim 9, wherein the at least one MFA failure condition corresponding to the at least one failed login attempt of the user comprises multiple MFA login failures of the user.

15. The system of claim 9, wherein the at least one MFA failure condition corresponding to the at least one failed login attempt of the user comprises at least one MFA push request being rejected by the user.

16. The system of claim 9, wherein the at least one MFA failure condition corresponding to the at least one failed login attempt of the user comprises multiple MFA verification code failures.

17. A non-transitory computer-readable storage medium storing instructions that, when executed by at least one processor, cause the at least one processor to:
identify at least one multifactor authentication (MFA) failure condition corresponding to at least one failed login attempt of a user;
detect a successful login attempt of the user following the identification of the at least one MFA failure condition;
determine whether a login violation condition of the successful login attempt occurs within a first predetermined time period from the detection of the successful login attempt; and
determine an MFA attack occurs based on determining that the login violation condition occurs within the first predetermined time period.

18. The storage medium of claim 17, wherein the instructions, when executed, further cause the at least one processor to store a login history of the user over a second predetermined time period, the login history comprising at least one of an MFA login location history of the user and an MFA login internet protocol (IP) address history of the user.

19. The storage medium of claim 18, wherein the login violation condition of the successful login attempt comprises at least one of:
the successful login attempt occurring at a location not included in the MFA login location history of the user; and
the successful login attempt occurring with an IP address not included in the MFA login IP address history of the user.

20. The storage medium of claim 17, wherein the at least one MFA failure condition corresponding to the at least one failed login attempt of the user comprises at least one of:
multiple MFA push requests occurring;
multiple MFA push requests occurring with no successful login attempts;
multiple MFA login failures of the user;
at least one MFA push request being rejected by the user; and
multiple MFA verification code failures.
